(19) United States
(12) Patent Application Publication
(10) Pub. No.: US 2024/0287656 A1
(43) Pub. Date: Aug. 29, 2024

(54) ALLOY WITH COMPLEX COMPOSITION

(71) Applicant: HUBLOT SA, GENÈVE, Geneva (CH)

(72) Inventors: Mathias Buttet, Monnaz (CH); Sébastien Recalcati, Lausanne (CH)

(73) Assignee: HUBLOT SA, GENÈVE, Geneva (CH)

(21) Appl. No.: 18/293,506

(22) PCT Filed: Jul. 26, 2022
(86) PCT No.: PCT/EP2022/070897

§ 371 Date: Jan. 30, 2024

(30) Foreign Application Priority Data
Aug. 2, 2021 (CH) CH070124/2021

(51) Int. Cl. C22C 28/00; B22F 3/105

(52) U.S. Cl. CPC C22C 28/00; B22F 3/105; B22F 2003/1051

(57) ABSTRACT

The alloy includes scandium (Sc) at a fraction of greater than or equal to 30 at %, titanium (Ti), zirconium (Zr) and/or vanadium (V) and/or oxides, hydrides, borides, carbides and/or nitrides thereof, wherein at least two of the elements titanium, zirconium and vanadium and/or their oxides, hydrides, borides and/or carbides have a fraction greater than or equal to 15 at %.

The invention relates to an alloy, for example for a watch component, and to a watch component as such, in particular provided for the casing of a watch, such as a watch case, comprising such an alloy. It also relates to any other component of a means of transportation or of any apparatus comprising such an alloy. It also relates to a timepiece, such as a watch, or piece of jewelry, comprising such an alloy. Finally, it also relates to a process for the manufacture of such an alloy.

A watch case must be very hard, in order to offer good impact resistance and to resist scratches which damage its esthetic appearance. In the state of the art, a watch case is thus generally made of a metal material or a metal alloy. However, it is also very advantageous for comfortable wearing for a watch case to be light. These two properties of hardness and of lightness are generally incompatible, hard metals being naturally heavy and light metals naturally soft. In addition to watch cases, a hard and light material would be advantageous for many other watch components. The existing solutions are thus unsatisfactory in that they do not make it possible to reach a good hardness/density compromise.

Thus, an object of the present invention is to find a solution for forming a hard and light watch component.

Naturally, such a solution should advantageously attain other advantageous, indeed even essential, properties sought for a watch component, such as an attractive esthetic appearance, a high resistance to wear, in particular resistance to oxidation and to corrosion, a non-magnetic property, and the like.

To this end, the invention relates to an alloy, wherein it comprises scandium (Sc) according to a fraction of greater than or equal to 30 at %, titanium (Ti), zirconium (Zr) and/or vanadium (V) and/or their oxides, hydrides, borides, carbides and/or nitrides, at least two of the elements among titanium, zirconium and vanadium and/or their oxides, hydrides, borides, carbides and/or nitrides exhibiting a fraction of greater than or equal to 15 at %.

Advantageously, the alloy does not comprise aluminum (Al) and/or does not comprise lithium (Li).

The alloy can be chosen from:
SC₃₀ Ti₂₅ V₂₀Zr₂₅
SC₆₀ Ti₂₀ V₂₀
SC₃₃ Ti₃₃ V₃₃
SC₄₀ Ti₂₀ V₂₀Zr₂₀
SC₃₃ Ti₃₃Zr₃₃
Sc₆₀Zr₂₀ Ti₂₀

In addition, the alloy can comprise magnesium (Mg) and/or manganese (Mn) and/or yttrium (Y), and/or rare earth metals.

According to embodiments of the alloy:
any element of the alloy other than scandium (Sc), titanium (Ti), zirconium (Zr) and vanadium (V) exhibits an atomic proportion of less than or equal to 5 at %, indeed even of less than or equal to 3.5 at %, indeed even of less than or equal to 2 at %; and/or
the total proportion of the elements scandium (Sc), titanium (Ti), zirconium (Zr) and vanadium (V) is greater than or equal to 70 at %, indeed even greater than or equal to 80 at %, indeed greater than or equal to 90 at %; and/or
the total proportion of the elements scandium (Sc), titanium (Ti), zirconium (Zr), vanadium (V), magnesium (Mg), manganese (Mn), yttrium (Y) and/or rare earth metals is greater than or equal to 90 at %, indeed even greater than or equal to 95 at %.

The alloy can consist of an alloy of 4 to 13 elements inclusive.

The alloy can comprise:
scandium between 30 and 70 at % inclusive, indeed even between 40 and 70 at % inclusive, indeed even between 50 and 65 at % inclusive, indeed even between 30 and 60 at % inclusive, indeed even between 30 and 47 at % inclusive, indeed even between 30 and 45 at % inclusive; and
titanium between 5 and 35 at % inclusive, indeed even between 5 and 30 at % inclusive, indeed even between 15 and 25 at % inclusive, indeed even between 15 and 20 at % inclusive; and
zirconium between 0 and 30 at % inclusive, indeed even between 5 and 30 at % inclusive, indeed even between 5 and 25 at % inclusive, indeed even between 15 and 25 at % inclusive, indeed even between 15 and 20 at % inclusive, indeed even between 10 and 20 at % inclusive; and
vanadium between 0 and 30 at % inclusive, indeed even between 5 and 30 at % inclusive, indeed even between 5 and 25 at % inclusive, indeed even between 15 and 25 at % inclusive, indeed even between 15 and 20 at % inclusive, indeed even between 10 and 20 at % inclusive.

Scandium can be the element of the alloy which exhibits the greatest atomic percentage.

The alloy can exhibit a density of less than or equal to 4.5 g·cm⁻³, indeed even of less than or equal to 4.2 g·cm⁻³, indeed even of less than or equal to 4 g·cm⁻³, measured after its shaping and before any other treatment.

The alloy can exhibit a hardness of greater than or equal to 400 Hv, indeed even of greater than or equal to 500 Hv, indeed even of greater than or equal to 600 Hv, measured after its shaping and before any other treatment.

The alloy can consist of scandium (Sc), titanium (Ti), zirconium (Zr) and/or vanadium (V), and/or their oxides, hydrides, borides, carbides and/or nitrides, and optionally magnesium (Mg), manganese (Mn), yttrium (Y) and/or rare earth metals.

The invention also relates to a watch component, wherein it comprises an alloy as described above or wherein it is entirely formed of an alloy as described above.

The watch component can be a watch case, a bezel, a dial, a strap link, a strap or a clasp for a strap.

The invention also relates to a timepiece, in particular a watch, or a piece of jewelry, wherein it comprises a watch component as described above or wherein it comprises an alloy as described above.

The invention also relates to a component dedicated to the aeronautical sector, to the motor vehicle sector, to a means of transportation, to a measuring apparatus, to an exploration robot, to a weapon or to an energy production or storage device, wherein it comprises an alloy as described above.

The component can be entirely formed of an alloy as described above or can be a bulk part comprising an alloy as described above extending substantially over its entire thickness.

The invention also relates to a process for the manufacture of an alloy as described above or of a component as described above, wherein it comprises the following stages:
grinding of powders of pure elements to form an alloy powder;
cold shaping of the alloy powder.

The shaping stage can comprise a spark plasma sintering stage.

These objects, characteristics and advantages of the present invention will be set out in detail in the following description of particular embodiments given without implied limitation.

The invention is based on the manufacture and the use of a metal alloy having both a low density and a high hardness.

For this purpose, the invention is based on the definition of a multiphase alloy having a complex composition. The concept of complex concentrated alloys derives in particular from high entropy alloys (HEA). The latter can consist of at least five elements in proportions close to equimolar and forming a single solid solution.

More generally, the merging of at least four elements, indeed even at least five elements, forms an assembly which makes it possible to achieve noteworthy properties, far from the usual natural properties of simple metal alloys. The definition of complex concentrated alloys extends that of high entropy alloys by including alloys composed of three or four elements, multiphase alloys, and the concentration of one of the elements advantageously exceeding 35 at %.

The alloy according to the invention comprises the following four main elements: scandium (Sc), titanium (Ti), zirconium (Zn) and vanadium (V) and/or their oxides, hydrides, borides and/or carbides. The term “main elements” is understood to mean the fact that these elements are the four elements of greatest proportion present in the alloy. Preferably, these four main elements represent at least 70 at % inclusive, indeed even at least 80 at % inclusive, indeed even at least 90 at % inclusive, of the alloy (the percentages mentioned are thus atomic percentages).

The alloy according to the invention comprises scandium according to a fraction of greater than or equal to 30 at %. In addition, at least two of the elements from titanium, zirconium and vanadium exhibit a fraction of greater than or equal to 15 at %.

Each main element participates in contributing an advantageous property to the alloy. For example, scandium contributes its lightness, its color and its mechanical properties. Titanium contributes its hardness. Zirconium contributes resistance to oxidation. Vanadium contributes hardness.

Moreover, the combination of these four main elements makes it possible to form a multiphase alloy having a complex composition. It makes it possible to form an alloy, the noteworthy properties of which go well beyond the simple addition of the properties of each element, as will be made clear subsequently. To result in this alloy, it was also necessary to make a selection of elements for which the chemical compatibility between them was discovered to be particularly good.

According to a first embodiment of the invention, the alloy consists of these four main elements. Among the alloys of this first embodiment, it is possible to identify the following alloys (the indices representing the atomic percentages of each element):
SC₃₀ Ti₂₅ V₂₀Zr₂₅
SC₄₀ Ti₂₀ V20Zr₂₀

In a simplified alternative form, the embodiment could not comprise zirconium or could not comprise vanadium. By way of example, the following alloys can be used in the context of the invention:
SC₆₀ Ti₂₀ V₂₀
SC₃₃ Ti₃₃ V₃₃
Sc₃₃Zr₃₃ Ti₃₃
SC₆₀Zr₂₀ Ti₂₀.

Advantageously, the alloy contains neither aluminum (Al) nor lithium (Li). In other words, the mark of aluminum and/or lithium is not detectable in the alloy. As aluminum is very reactive with scandium, it would form intermetallics which would weaken the alloy. Lithium is very volatile, which would make the processing complex, and would also weaken the alloy by formation of intermetallics.

As mentioned above, the alloy can comprise one of the oxides and/or nitrides and/or hydrides and/or borides and/or carbides of the following elements: scandium, titanium, zirconium and vanadium.

According to a second embodiment of the invention, the alloy comprises at least one other “secondary” element, it being possible for the at least one secondary element to be magnesium (Mg) and/or manganese (Mn) and/or yttrium (Y) and/or rare earth metals.

Advantageously, any secondary element will be present according to an atomic proportion of less than or equal to 5 at %, indeed even of less than or equal to 3.5 at %, indeed even of less than or equal to 2 at %.

Advantageously again, the total proportion of the elements scandium (Sc), titanium (Ti), zirconium (Zr), vanadium (V), magnesium (Mg), manganese (Mn), yttrium (Y) and/or rare earth metals is greater than or equal to 90 at %, indeed even greater than or equal to 95 at %.

Finally, the alloy according to the invention can thus comprise 3, 4 or 5 elements. In an alternative form, it can comprise more than 5 elements, in particular between 6 and 13 elements.

Thus, the alloy can consist of scandium (Sc), titanium (Ti), zirconium (Zr) and/or vanadium (V), and optionally magnesium (Mg), manganese (Mn), yttrium (Y) and/or rare earth metals.

Advantageously, in all these embodiments, each of the four main elements will be present in the following atomic proportions:
scandium between 30 and 70 at % inclusive, indeed even between 40 and 70 at % inclusive, indeed even between 50 and 65 at % inclusive, indeed even between 30 and 60 at % inclusive, indeed even between 30 and 47 at % inclusive, indeed even between 30 and 45 at % inclusive; and
titanium between 5 and 35 at % inclusive, indeed even between 5 and at % inclusive, indeed even between 15 and 25 at % inclusive, indeed even between 15 and 20 at % inclusive; and
zirconium between 0 and 30 at % inclusive, indeed even between 5 and 30 at % inclusive, indeed even between 5 and 25 at % inclusive, indeed even between 15 and 25 at % inclusive, indeed even between 15 and 20 at % inclusive, indeed even between 10 and 20 at % inclusive; and
vanadium between 0 and 30 at % inclusive, indeed even between 5 and 30 at % inclusive, indeed even between 5 and 25 at % inclusive, indeed even between 15 and 25 at % inclusive, indeed even between 15 and 20 at % inclusive, indeed even between 10 and 20 at % inclusive.

Advantageously, in all the embodiments of the invention, scandium will be present with the greatest atomic percentage.

It appears that such an alloy according to the invention makes it possible to achieve a low density and a high hardness. Advantageously, the elements of the alloy will be chosen so that the resulting alloy exhibits a density of less than or equal to 4.5 g·cm⁻³, indeed even of less than or equal to 4.2 g·cm⁻³, indeed even of less than or equal to 4 g·cm⁻³, and a hardness of greater than or equal to 400 Hv, indeed even of greater than or equal to 500 Hv, indeed even of greater than or equal to 600 Hv, measured after the shaping stage described below and before any other optional treatment. It is also noteworthy that the alloy according to the invention exhibits a high microstructural stability, being able to even resist as far as a temperature of greater than 900° C., indeed even of greater than 1000° C.

Advantageously, the alloy is a completely metallic alloy. It appears that the invention makes it possible to obtain an alloy which is lighter than aluminum and harder than hardened steel, while being completely stainless and non-magnetic.

Such an alloy can have a simple, single-phase or two-phase, crystalline, in particular nanocrystalline, structure. In an alternative form, the alloy can exhibit an amorphous structure.

The invention also relates to a watch component, wherein it comprises an alloy as described above. According to one embodiment, the watch component can be entirely formed of an alloy according to the invention. In an alternative form, only a part of said component can be formed of such an alloy.

According to one embodiment, the watch component can be a watch case, a bezel, a dial, a strap link, a strap (bracelet), a clasp for a strap, and the like.

The invention also relates to a timepiece or a piece of jewelry which comprises an alloy as described above or a watch component as described above. The timepiece according to one embodiment of the invention can be a watch, such as a wristwatch.

The invention was designed for the field of watchmaking, indeed even of jewelry. However, it appears that the alloy according to the invention might advantageously be used in other fields as a result of its many noteworthy properties. Thus, this alloy might, for example, be used in the aerospace sector, the aeronautical sector or the motor vehicle sector, more generally for any transportation industry, and also for the energy and armaments fields. Thus, the invention also relates to a component dedicated to the aerospace sector, to the aeronautical sector, to the motor vehicle sector, to a means of transportation, to a measuring apparatus, such as a robot intended to take measurements and/or a space exploration robot, an energy production or storage device, and the like, which is formed in all or part of the alloy of the invention. A component comprising this alloy can advantageously be entirely composed of the alloy, that is to say that the alloy will form a bulk component. The alloy will thus extend over the entire thickness of the component. In an alternative form, such a component can be predominantly formed of said alloy, which extends in particular into its core. Said alloy can optionally be covered with a surface coating to give it a particular color or a particular appearance or a particular surface protection.

Finally, the invention also relates to a process for the manufacture of an alloy as described above. There already exist processes for the manufacture of high entropy alloys, and processes for the manufacture of alloys comprising many elements.

With the alloy according to the invention, the elements exhibit a high reactivity in the liquid state. For example, molten scandium is extremely difficult to handle in the liquid state. Liquid titanium is very reactive with atmospheric oxygen; it forms weakening oxides.

Thus, according to the embodiment of the invention, the manufacturing process comprises a mechanical alloying stage.

More precisely, in a first stage of the process, the pure elements of the alloy to be manufactured, in powder form, are placed in a high-energy planetary mill. The energy generated by the impacts between the beads of the mill and the powders of pure elements has two effects:
a first mechanical crushing effect makes it possible for the various elements to come into contact. The ductile particles deform to encompass the solid particles;
a second effect is that the heat generated by the impacts makes it possible to activate the solid-state diffusion of the elements, and causes the dissolution of the alloy.

After a certain grinding time, the result is a new alloy powder having a uniform composition. As a side note, the grinding is carried out under vacuum or in the presence of an inert gas.

Subsequently, the alloy powder is shaped in a second stage.

The technique used for the shaping of the alloy is spark plasma sintering. The spark plasma sintering technique consists of the simultaneous application of a pulsed current through the powder and of a pressure. It makes it possible to use lower sintering temperatures and also shorter times for maintaining under pressure and thus to obtain rapid sintering. This technique makes it possible to obtain a fine microstructure, the size of the grains of which can be in a nanometric size range.

As a side note, this second stage uses low sintering temperatures, to avoid any risk of evaporation, and a short duration, to avoid any risk of demixing of the alloy.

After densification, the sintered shapes obtained by the second stage can be subjected to any conventional treatment in a third stage. For example, they can be conventionally machined.

1. An alloy comprising:
scandium (Sc) according to a fraction of greater than or equal to 30 at %,
titanium (Ti), zirconium (Zr) and/or vanadium (V) and/or their oxides, hydrides, borides, carbides and/or nitrides,
at least two of the elements among titanium, zirconium and vanadium and/or their oxides, hydrides, borides, carbides and/or nitrides, exhibiting a fraction of greater than or equal to 15 at %.

2. The alloy as claimed in claim 1, wherein
the alloy does not comprise aluminum (Al), and/or
the alloy does not comprise lithium (Li).

3. The alloy as claimed in the preceding claim, wherein the alloy is chosen from:
Sc₃₀ Ti₂₅ V₂₀Zr₂₅
SC₆₀ Ti₂₀ V₂₀
Sc₃₃ Ti₃₃ V₃₃
Sc₄₀ Ti₂₀ V₂₀Zr₂₀
Sc₃₃ Ti₃₃Zr₃₃
Sc₆₀Zr₂₀Ti₂₀

4. The alloy as claimed in claim 1, wherein the alloy comprises magnesium (Mg) and/or manganese (Mn) and/or yttrium (Y) and/or rare earth metals.

5. The alloy as claimed in claim 1, wherein:
any element of the alloy other than scandium (Sc), titanium (Ti), zirconium (Zr) and vanadium (V) exhibits an atomic proportion of less than or equal to 5 at %; and/or
a total proportion of the elements scandium (Sc), titanium (Ti), zirconium (Zr) and vanadium (V) is greater than or equal to 70 at %; and/or
a total proportion of the elements scandium (Sc), titanium (Ti), zirconium (Zr), vanadium (V), magnesium (Mg), manganese (Mn), yttrium (Y) and/or rare earth metals is greater than or equal to 90 at %.

6. The alloy as claimed in claim 4, wherein the alloy consists of to 13 elements inclusive.

7. The alloy as claimed in claim 1, wherein the alloy comprises:
scandium between 30 and 70 at % inclusive; and
titanium between 5 and 35 at % inclusive; and
zirconium between 0 and 30 at % inclusive; and
vanadium between 0 and 30 at % inclusive.

8. The alloy as claimed in claim 1, wherein scandium is the element of the alloy which exhibits the greatest atomic percentage.

9. The alloy as claimed in claim 1, wherein the alloy exhibits a density of less than or equal to 4.5 g·cm⁻³, measured after its shaping of the alloy and before any other treatment.

10. The alloy as claimed in claim 1, wherein the alloy exhibits a hardness of greater than or equal to 400 Hv, measured after shaping of the alloy and before any other treatment.

11. The alloy as claimed in claim 1, wherein the alloy consists of scandium (Sc), titanium (Ti), zirconium (Zr) and/or vanadium (V), and/or their oxides, hydrides, borides, carbides and/or nitrides, and optionally magnesium (Mg), manganese (Mn), yttrium (Y) and/or rare earth metals.

12. A watch component comprising the alloy as claimed in claim 1.

13. The watch component as claimed in claim 12, which is a watch case, a bezel, a dial, a strap link, a strap, or a clasp for a strap.

14. A timepiece comprising a watch component as claimed in claim 12.

15. A component dedicated to the aeronautical sector, to the motor vehicle sector, to a means of transportation, to a measuring apparatus, to an exploration robot, to a weapon or to an energy production or storage device, wherein the component comprises an alloy as claimed in claim 1.

16. The component as claimed in claim 12, which is a bulk part comprising the alloy extending substantially over an entire thickness of the bulk part.

17. A process for the manufacture of the component as claimed in claim 12, wherein the process comprises:
grinding powders of pure elements to form an alloy powder;
cold shaping the alloy powder.

18. The process for the manufacture of a component as claimed in claim 17, wherein the shaping comprises carrying out a spark plasma sintering.

19. The alloy as claimed in claim 5, wherein:
any element of the alloy other than scandium (Sc), titanium (Ti), zirconium (Zr) and vanadium (V) exhibits an atomic proportion of less than or equal to 2 d at %; and/or
a total proportion of the elements scandium (Sc), titanium (Ti), zirconium (Zr) and vanadium (V) is greater than or equal to 90 at %; and/or
a total proportion of the elements scandium (Sc), titanium (Ti), zirconium (Zr), vanadium (V), magnesium (Mg), manganese (Mn), yttrium (Y) and/or rare earth metals is greater than or equal to 95 at %.

20. The alloy as claimed in claim 7, wherein the alloy comprises:
scandium between 30 and 45 at % inclusive; and
titanium between 15 and 20 at % inclusive; and
zirconium between 10 and 20 at % inclusive; and
vanadium between 10 and 20 at % inclusive.
